(19) United States
(12) Patent Application Publication
(10) Pub. No.: US 2026/0291386 A1
(43) Pub. Date: Sep. 24, 2026

(54) MODE TRANSITION OF POWER STAGE CIRCUIT FOR SWITCHING CAPACITOR CONVERTER

(71) Applicant: Monolithic Power Systems, Inc., Kirkland, WA (US)

(72) Inventors: Le Kong, San Jose, CA (US); Cong Deng, San Jose, CA (US)

(21) Appl. No.: 19/083,090

(22) Filed: Mar. 18, 2025

(51) Int. Cl. H02M 3/07; H02M 1/00; H02M 3/158

(52) U.S. Cl. CPC H02M 3/07; H02M 1/0009; H02M 1/0095; H02M 3/158

(57) ABSTRACT

A power stage circuit includes a first phase switch circuit, a second phase switch circuit, a driving control circuit, a zero current detection circuit and a mode selection circuit. The first phase switch circuit is configured to be coupled to the second phase switch circuit via a first flying capacitor. The zero current detection circuit is configured to generate a first zero crossing signal indicating whether the first output current is essentially zero, and generate a second zero crossing signal indicating whether the second output current is essentially zero. The mode selection circuit is configured to trigger a phase replicate mode in response to the second zero crossing signal and the first phase control signal. During the phase replicate mode, the second phase control signal transitions to a high logic level before the first output current decreases to essentially zero.

### TECHNICAL FIELD

The present disclosure relates generally to power circuits, and more particularly but not exclusively to switching capacitor converters.

### BACKGROUND OF THE INVENTION

Switching mode power supply has been widely used in power applications. Multiphase voltage regulator includes multiple (e.g., n) power stage circuits, where n is a positive integer greater than 1. Specifically, the n power stage circuits are coupled in parallel, and each of the power stage circuit to provide a higher output current to the load. Each power stage circuits is configured to share the input voltage and the output voltage and provide a phase current to a load. In one embodiment, the n power stage circuits are interleaved in n phases to reduce current ripple at the input and output and improve efficiency. Typically, each of the n power stage circuits is an integrated circuit (IC), and a multiphase controller is also an IC configured to provide the n phase control signals to respectively control the n power stage ICs. Each phase of the power stage IC is to form a buck converter. A switching capacitor converter having a flying capacitor, such as series capacitor buck, 3 level buck converter, hybrid buck converter, hybrid switched-capacitor converter are proposed to reduce the voltage stress on switches. Furthermore, the ripple current of the inductor current is reduced, result in smaller inductor size and fewer switching loss. As a result, the switching capacitor converter achieves high efficiency and power density. However, it is desirable to improve the efficiency of the switching capacitor converter.

### SUMMARY OF THE INVENTION

According to an embodiment of the present disclosure, a power stage circuit is provided. The power stage circuit includes a first phase switch circuit, a second phase switch circuit, a driving control circuit, a zero current detection circuit and a mode selection circuit. The first phase switch circuit has at least one switch, and is configured to provide a first output current. The second phase switch circuit has at least one switch, and is configured to provide a second output current. The first phase switch circuit is configured to be coupled to the second phase switch circuit via a first flying capacitor. The driving control circuit is configured to receive a control signal and provide a first phase control signal to the first phase switch circuit, and provide a second phase control signal to the second phase switch circuit. The zero current detection circuit is configured to generate a first zero crossing signal indicating whether the first output current is essentially zero, and generate a second zero crossing signal indicating whether the second output current is essentially zero. The mode selection circuit is configured to receive the first zero crossing signal and the second zero crossing signal, and trigger a phase replicate mode in response to the second zero crossing signal and the first phase control signal. During the phase replicate mode, the second phase control signal transitions to a high logic level before the first output current decreases to essentially zero.

According to yet another embodiment of the present disclosure, a power stage circuit is provided. The power stage circuit includes a switch circuit, a driving control circuit, a pre-charge monitor circuit, and a report circuit. The switch circuit has at least one switch, and one of the at least one switch is configured to be coupled to a flying capacitor. The driving control circuit is configured to receive a control signal and provide at least one driving signal to a control terminal of the at least one switch. The pre-charge monitor circuit is configured to monitor a voltage across the flying capacitor. The report circuit is configured to provide a report signal indicating a pre-charge period of the flying capacitor is finished.

According to yet another embodiment of the present disclosure, an integrated circuit is provided. The integrated circuit includes a switching control pin, a first switching pin, a second switching pin, a first high-side switch, a first low-side switch, a second high-side switch, a second low-side switch, and a driving control circuit. The switching control pin is configured to receive a control signal. The first switching pin is configured to provide a first output current. The second switching pin is configured to provide a second output current. The first high-side switch has a first terminal, a second terminal and a third terminal. The first terminal of the first high-side switch is configured to receive an input voltage. The first low-side switch has a first terminal, a second terminal and a third terminal. The first terminal of the first low-side switch is coupled to the first switching pin, and the second terminal of the first low-side switch is configured to be coupled to a reference voltage level.

The second high-side switch has a first terminal, a second terminal and a third terminal. The first terminal of the second high-side switch is coupled to the second terminal of the first high-side switch. The second low-side switch has a first terminal, a second terminal and a third terminal. The first terminal of the second low-side switch is coupled to the second terminal of the second high-side switch and the second switching pin, and the second terminal of the second low-side switch is configured to be coupled to the reference voltage level. The driving control circuit is configured to receive a control signal and provide a first driving signal to the first high-side switch, provide a second driving signal to the first low-side switch, provide a third driving signal to the second high-side switch and provide a fourth driving signal to the second low-side switch. A phase replicate mode is triggered in response to a second zero crossing signal and the control signal. The second zero crossing signal indicates whether the second output current is essentially zero. When the phase replicate mode is triggered, the third driving signal overlaps with the second driving signal

According to yet another embodiment of the present disclosure, a gate driving circuit for a switching capacitor converter is provided. The gate driving circuit includes a driving control circuit, a zero current detection circuit, and a mode selection circuit. The driving control circuit is configured to receive a control signal, provide a first phase control signal to a first phase switch circuit, and provide a second phase control signal to a second phase switch circuit. The zero current detection circuit is configured to generate a first zero crossing signal indicating whether a first output current is essentially zero, and generate a second zero crossing signal indicating whether a second output current is essentially zero. The mode selection circuit configured to receive the first zero crossing signal and the second zero crossing signal, and trigger a phase replicate mode in response to the second zero crossing signal and the first phase control signal. When the phase replicate mode is triggered, the second phase control signal transitions to a high logic level before the first output current decreases to essentially zero.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 is a schematic block diagram of a multiphase voltage regulator in accordance with an embodiment of the present disclosure.

FIG. 2A is a schematic circuit diagram of a switching capacitor converter in accordance with an embodiment of the present disclosure.

FIG. 2B is a schematic circuit diagram of a switching capacitor converter in accordance with another embodiment of the present disclosure.

FIG. 3 is a schematic block diagram of a power stage IC in accordance with an embodiment of the present disclosure.

FIG. 4 is a schematic block diagram of a power stage IC in accordance with another embodiment of the present disclosure.

FIG. 5 shows a working principle of the switching capacitor converter as shown in FIG. 2A in accordance with an embodiment of the present disclosure.

FIG. 6 shows the phase replicate mode entry process in accordance with an embodiment of the present disclosure.

FIG. 7 shows the phase replicate mode exit process in accordance with an embodiment of the present disclosure.

FIG. 8 is a schematic circuit diagram of a mode selection circuit in accordance with an embodiment of the present disclosure.

FIG. 9 is a flowchart of a method for controlling a switching capacitor converter in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

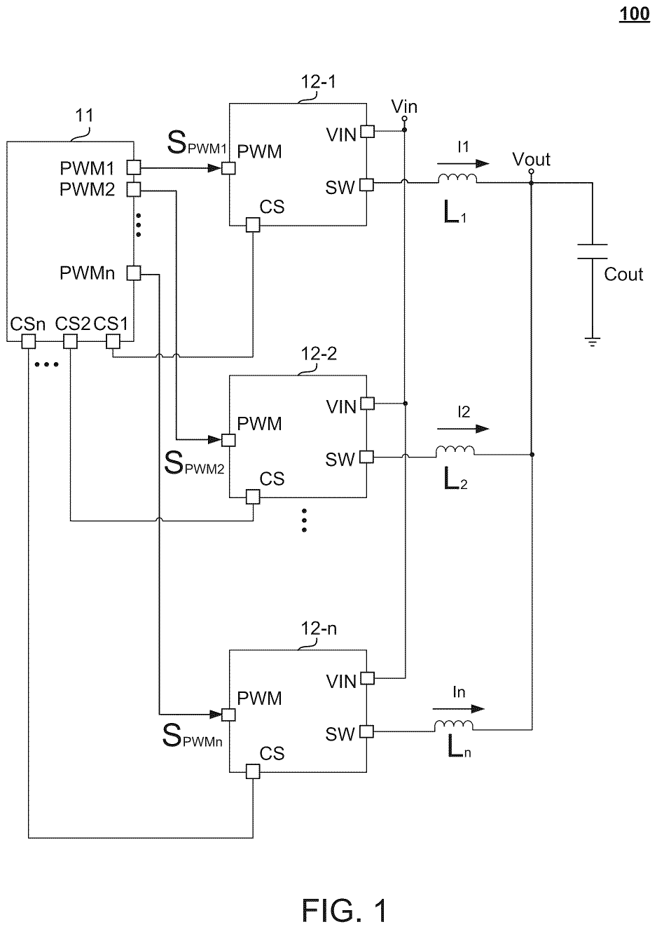

FIG. 1 is a schematic block diagram of a multiphase voltage regulator 100 in accordance with an embodiment of the present disclosure. The multiphase voltage regulator 100 includes a control circuit 11 and multiple (e.g., n) power stage circuits 12-1 to 12-n, where n is a positive integer greater than 1. The n power stage circuits are coupled in parallel, and each of the power stage circuit to provide a phase current to the load. Each power stage circuits is configured to share the input voltage Vin and the output voltage Vout and provide a phase current (e.g., I1, I2, . . . , In) to a load. In one embodiment, the n power stage circuits are interleaved in n phases to reduce current ripple at the input and output and improve efficiency. The control circuit 11 is configured to provide the n phase control signals (e.g., S_{PWM1}, S_{PWM2}, . . . , S_{PWMn}) to respectively control the n power stage circuits.

In one implementation, the multiphase voltage regulator 100 is a multiphase buck converter. However, the present disclosure is not limited thereto. The multiphase voltage regulator 100 may be a multiphase boost converter, a trans-inductor voltage regulator (TLVR), a multiphase DC-DC converters, or any multiphase converters. In some implementations, the multiphase voltage regulator 100 is an isolated converter. In some other implementations, the multiphase voltage regulator 100 is a non-isolated converter.

In one embodiment, the control circuit 11 is a multiphase controller integrated circuit (IC) having n switching control pins (e.g., PWM1-PWMn). In one embodiment, the multiphase controller IC 11 includes a switching control circuit (not shown). Specifically, the switching control pins PWM1-PWMn are coupled to the respective switching control pin PWM of the power stage ICs 12-1 to 12-n. For instance, the control signal (e.g., S_{PWM1}, S_{PWM2}, . . . , S_{PWMn}) has three states, a high logic level (e.g., 2-3.3V) to turn on the high-side switch, a low logic level (e.g., 0-1V) to turn on the low-side switch, and a tri-state logic level (e.g., 1-2V) to make the multiphase voltage regulator 100 in the Hi-Z mode (or inactive).

In one embodiment, the multiphase controller 11 further includes a current sense circuit (not shown) configured to receive current sense signals indicating the respective phase currents of the power stage circuits via the current sense pin (e.g., CS1, CS2, . . . , CSn). In one embodiment, the current sense signals are used to provide a total load current sense signal via the pin IMON.

In one embodiment, the multiphase controller IC 11 further includes a control loop circuit (not shown) configured to regulate the output voltage Vout. For example, the control loop circuit sense the feedback voltage via the feedback pin FB. The feedback voltage represents the output voltage Vout. In one embodiment, the feedback voltage is compared with a reference signal to generate a compensation signal (e.g., via an error amplifier EA), and the compensation signal is compared with a ramp signal received via the pin RAMP to generate a control signal (e.g., via a PWM comparator). In another embodiment, the feedback voltage is compared with a reference signal to generate a compensation signal (e.g., via an error amplifier EA), and the compensation signal is compared with the inductor current to generate the control signal (e.g., via a PWM comparator). In yet another embodiment, the feedback voltage is compared with a reference signal to generate a compensation signal (e.g., via a PWM comparator), and the control signal is generated in response to the compensation signal and an on-time.

In one embodiment, each of the power stage circuits 12-1 to 12-n is an IC. Each of the power stage circuits 12-1 to 12-n includes a VIN pin configured to receive the input voltage Vin, a SW pin configured to provide the output voltage Vout via the inductor (e.g., L₁, L₂, . . . , Lₙ), a switching control pin (e.g., PWM) configured to receive the control signals (e.g., S_{PWM1}, S_{PWM2}, . . . , S_{PWMn}) from the multiphase controller IC 11, and a current report pin (e.g., CS) configured to transmit a current sense signal to the multiphase controller IC 11. The current sense signal indicates the current flowing through the inductor.

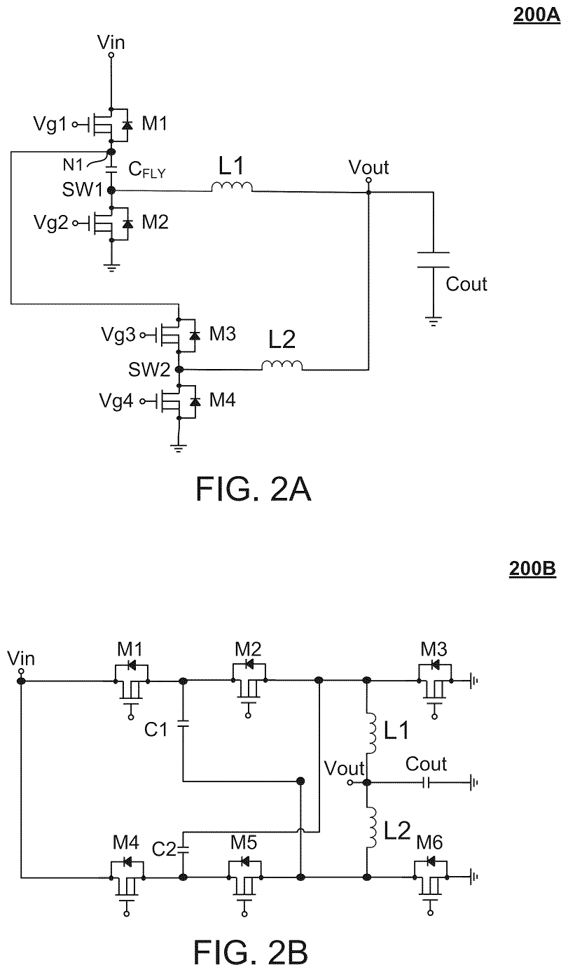

In one embodiment, the multiphase voltage regulator 100 is a converter including one or more flying capacitors. For instance, FIG. 2A is a schematic circuit diagram of a switching capacitor converter 200A in accordance with an embodiment of the present disclosure. As shown in FIG. 2A, the s switching capacitor converter 200A includes a switching circuit, inductors L1 and L2, and a flying capacitor C_{FLY}. In one embodiment, an output capacitor Cout is coupled between the output terminal Vout and a ground. As shown in FIG. 2A, the switching circuit has 4 power switches M1-M4. In one embodiment, the power switches M1-M4 may include Metal-Oxide-Semiconductor Field-Effect Transistor (MOSFETs). In some embodiments, the power switches M1-M4 may include, but not limited to, a bipolar transistor (BJT), a field-effect transistor (FET), or an insulated-gate bipolar transistor (IGBT), a high electron mobility transistor (HEMT), a junction field-effect transistor (JFET), a Gate Turn-off Thyristor (GTO) or a Gate-Commutated Thyristor (GCT). The power switch M1 and the power switch M2 are coupled in series between the input terminal Vin and the ground, and the flying capacitor C_{FLY} is coupled between the . power switch M1 and the power switch M2. Specifically, the flying capacitor C_{FLY} is coupled to between the node N1 and the node SW1. The power switches M3 and M4 is coupled in series between the node N1 and the ground. The switching capacitor converter 200A is a 2-phase converter. Each phase includes a high side switch (e.g., M1, M3) and a low side switch (e.g., M2, M4), and configured to provide the output voltage via each inductor (L1, or L2). The flying capacitor C_{FLY} acts as a voltage divider to divide the input voltage VIN. The flying capacitor C_{FLY} temporarily stores energy during a switching cycle and transfer energy to the output stage, and the temporarily stored energy is proportional to the duty cycle. During steady state, the voltage across the flying capacitor C_{FLY} is the output voltage Vo divided by the duty cycle D. In one implementation, the voltage across the flying capacitor C_{FLY} is approximately half of the input voltage (½ *VIN) at steady state.

FIG. 2B is a schematic circuit diagram of a switching capacitor converter 200B in accordance with another embodiment of the present disclosure. In this embodiment, the switching capacitor converter 200B includes two flying capacitors C1 and C2. As shown in FIG. 2B, the switching circuit has 6 power switches M1-M6. The switching capacitor converter 200B is a 2-phase converter. The first phase includes the power switch M1, the flying capacitor C1, the power switches M5 and M6, and the inductor L2. The second phase includes the power switch M4, the flying capacitor C2, the power switches M2 and M3, and the inductor L1. In one embodiment, a pre-charge circuit (not shown) is coupled to the input terminal Vin and at least one terminal of the flying capacitor (e.g., C1 and/or C2) to charge the flying capacitor (e.g., C1 and/or C2) during start-up of the switching capacitor converter 200B.

FIGS. 2A and 2B show buck type switching converter with one and two flying capacitor. However, the present disclosure is not limited thereto. In another embodiment, the switching converter is a boost type converter. In some embodiments, the switching converter is a buck-boost type converter. In some other embodiments, the switching converter is a switched capacitor type converter. In one implementation, the switching converter includes one or more flying capacitor coupled between at least one of the power switch. In one example, one or more flying capacitor is coupled at the input circuit that is between the input terminal and the inductor. In another example, one or more flying capacitor is coupled at the output circuit that is coupled to the output terminal. Although FIGS. 2A and 2B show a two phase switching converter, however, the present disclosure is not limited thereto. The switching converter may include 3 or more phases.

The switching capacitor converter may include a switched capacitor circuit and a buck converter. For instance, the switching capacitor converter topology may include, but not limited to, series capacitor buck converters, hybrid buck converters, hybrid switched-capacitor converters.

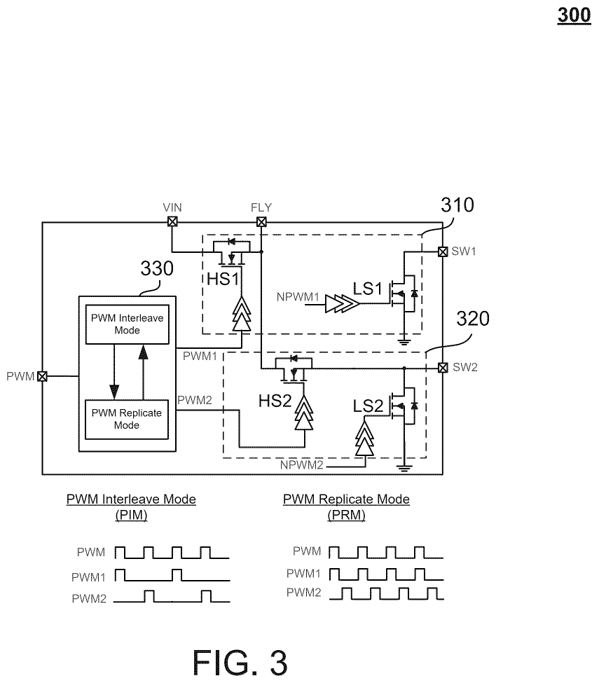

FIG. 3 is a schematic block diagram of a power stage IC 300 in accordance with an embodiment of the present disclosure. The power stage IC 300 includes a first phase switch circuit 310, a second phase switch circuit 320, and a driving control circuit 330. The first phase switch circuit 310 has at least one switch, and one of the at least one switch is configured to be coupled to a flying capacitor (e.g., via pin FLY). The first phase switch circuit 310 is configured to provide a first output current (e.g., via switching pin SW1). The second phase switch circuit 320 has at least one switch. The second phase switch circuit 320 is configured to provide a second output current (e.g., via switching pin SW2).

In one embodiment, the power stage IC 300 are used to form the switching capacitor converter 200A as shown in FIG. 2A. In one implementation, the power switches HS1, LS1, HS2 and LS2 are n-type MOSFETs. The first terminal (e.g., drain) of a first high-side switch HS1 is coupled to the VIN pin configured to receive the input voltage, the second terminal (e.g., source) of the first high-side switch HS1 is coupled to a flying capacitor C_{FLY} via the FLY pin, and the first terminal (e.g., drain) of the first low-side switch LS1 is coupled to the second terminal (e.g., source) of the first high-side switch HS1 via the flying capacitor C_{FLY}. The second terminal (e.g., source) of the first low-side switch LS1 is coupled to the ground. The first terminal (e.g., drain) of the second high-side switch HS2 is coupled to the second terminal (e.g., source) of the first high-side switch HS1, the second terminal (e.g., source) of the second high-side switch HS2 is coupled to the SW2 pin and the first terminal (e.g., drain) of the second low-side switch LS2. The second terminal (e.g., source) of the second low-side switch LS2 is configured to be coupled to the reference voltage level (e.g., the ground).

The control terminals (e.g., gate) of the power switches (e.g., HS1, LS1, HS2 and LS2) are coupled to the driving control circuit 330. The driving control circuit 330 is configured to receive a control signal from the switching control pin PWM and provide the driving signals PWM1, NPWM1, PWM2, NPWM2 to the gate terminals of the power switches HS1, LS1, HS2 and LS2, respectively. Specifically, the power switches HS1, LS1, HS2 and LS2 are turned on and turned off in response to the driving signals PWM1, NPWM1, PWM2, NPWM2, respectively, and provide switching signals at the SW1 pin and the SW2 pin.

In another embodiment, the power stage IC 300 are used to form the switching capacitor converter 200B as shown in FIG. 2B. However, the present disclosure is not limited thereto. The switch circuit 310/320 of the power stage IC 300 includes multiple switches with at least one of the switches is configured to be coupled to one or more flying capacitor. That is, the power stage IC may be used to form various types of converter topology.

As shown in FIG. 3, the power stage IC 300 has a phase interleave mode (PIM) and a phase replicate mode (PRM). During the phase interleave mode, the control signal PWM is distributed evenly to the first phase control signal PWM1 and the second phase control signal PWM2. That is, each phase control signal is interleaved (e.g., with 180 degrees) out of phase with respect to each other. Specifically, the first phase control signal PWM1 is synchronous with the odd pulses of the control signal PWM, and the second phase control signal PWM2 is synchronous with the even pulses of the control signal PWM. Under PIM, for each phase, the high side switch HS1/HS2 will be turned on when the control signal PWM1/2 is at the high logic level. When the control signal PWM1/2 is at low logic level, the low side switch LS1/LS2 will be turned on until the inductor current reaches zero. On the other hand, under phase replicate mode (PRM), the first phase control signal PWM1 is the same and/or synchronous with the control signal PWM, while the second phase control signal PWM2 is the replica of the first phase control signal PWM1 with the same on time after a delay time. During the phase replicate mode, the second phase control signal PWM2 transitions to a high logic level before the first output current decreases to essentially zero. That is, the driving signal PWM2 overlaps with the driving signal NPWM1. In one embodiment, the PRM is triggered during light load operation. In one embodiment, the PIM is triggered during normal operation.

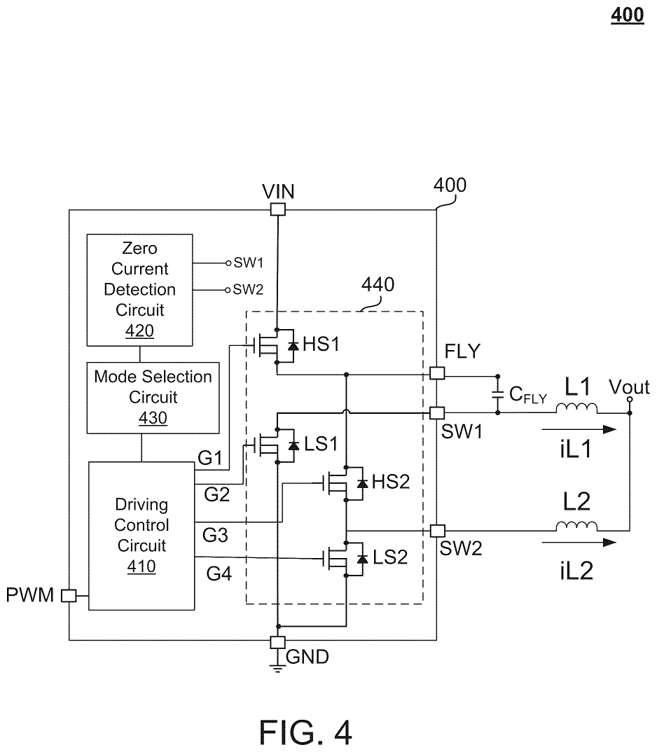

FIG. 4 is a schematic block diagram of a power stage IC 400 in accordance with another embodiment of the present disclosure. The power stage IC 400 includes a switching circuit 440, a driving control circuit 410, a zero current detection circuit 420, and a mode selection circuit 430. The switch circuit 440 has at least one switch, and one of the at least one switch is configured to be coupled to a flying capacitor. In one embodiment, the power stage IC 400 are used to form the switching capacitor converter 200A as shown in FIG. 2A. In one implementation, the switch circuit 440 has power switches HS1, LS1, HS2 and LS2. The first terminal (e.g., drain) of a first high-side switch HS1 is coupled to the VIN pin configured to receive the input voltage, the second terminal (e.g., source) of the first high-side switch HS1 is coupled to a flying capacitor C_{FLY} via the FLY pin, and the first terminal (e.g., drain) of the first low-side switch LS1 is coupled to the second terminal (e.g., source) of the first high-side switch HS1 via the flying capacitor C_{FLY}. The second terminal (e.g., source) of the first low-side switch LS1 is coupled to the GND pin configured to be coupled to a reference voltage level (e.g., the ground). The first terminal (e.g., drain) of the second high-side switch HS2 is coupled to the second terminal (e.g., source) of the first high-side switch HS1, the second terminal (e.g., source) of the second high-side switch HS2 is coupled to the SW2 pin and the first terminal (e.g., drain) of the second low-side switch LS2. The second terminal (e.g., source) of the second low-side switch LS2 is configured to be coupled to the reference voltage level (e.g., the ground).

The control terminals (e.g., gate) of the power switches (e.g., HS1, LS1, HS2 and LS2) are coupled to the driving control circuit 410. The driving control circuit 410 is configured to receive a control signal from the switching control pin PWM and provide the driving signals G1-G4 to the gate terminals of the power switches HS1, LS1, HS2 and LS2, respectively. Specifically, the power switches HS1, LS1, HS2 and LS2 are turned on and turned off in response to the driving signals G1-G4, respectively, and provide output current at the SW1 pin and the SW2 pin.

The zero current detection circuit 420 is configured to generate a first zero crossing signal indicating whether the first output current (i.e., the inductor current iL1) is essentially zero, and generate a second zero crossing signal indicating whether the second output current (i.e., the inductor current iL2) is essentially zero. For instance, a zero crossing signal LSZCD1/LSZCD2 is at a high logic level when the inductor current iL1/iL2 is essentially zero. A low logic level of the zero crossing signal LSZCD1/LSZCD2 indicates the inductor current iL1/iL2 is greater than essentially zero. In one implementation, the zero crossing signal LSZCD1/LSZCD2 is triggered to be high when the inductor current decreases to zero. In another implementation, the zero crossing signal LSZCD1/LSZCD2 is triggered when the inductor current is 0.2 A. In yet another implementation, the zero crossing signal LSZCD1/LSZCD2 is triggered when the inductor current is −0.2 A. In some implementations, the zero crossing signal LSZCD1/LSZCD2 is triggered when the inductor current is within a range of zero (e.g., ±0.5 A).

The mode selection circuit 430 is configured to receive the first zero crossing signal and the second zero crossing signal, and trigger a phase replicate mode in response to the second zero crossing signal and the first phase control signal. When the phase replicate mode is triggered, the second phase control signal transitions to a high logic level before the first output current decreases to essentially zero.

In another embodiment, the power stage IC 400 are used to form the switching capacitor converter 200B as shown in FIG. 2B. However, the present disclosure is not limited thereto. The switching circuit 440 of the power stage IC 400 includes multiple switches with at least one of the switches is configured to be coupled to one or more flying capacitor. That is, the power stage IC may be used to form various types of converter topology.

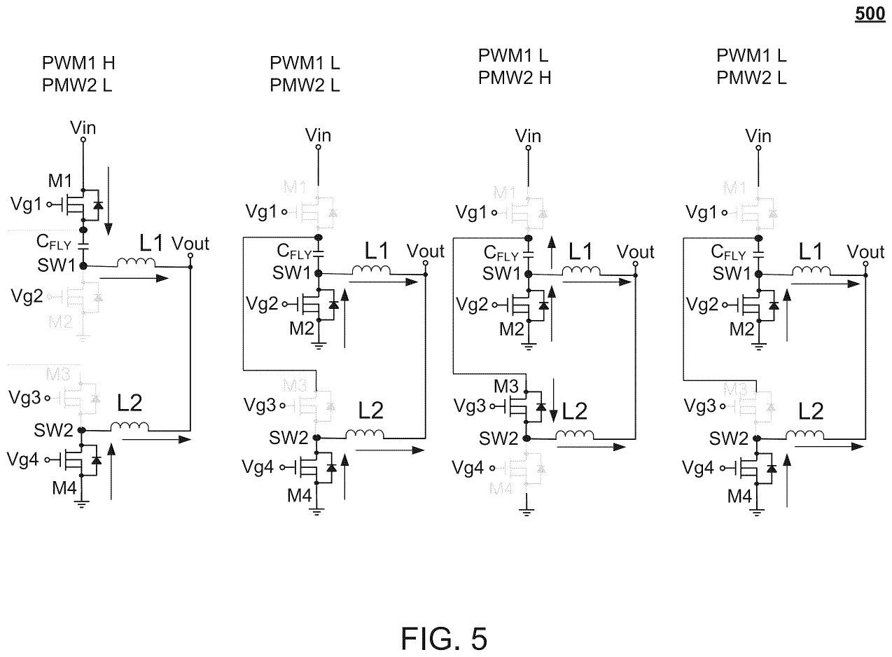

FIG. 5 shows a working principle of the switching capacitor converter 200A as shown in FIG. 2A in accordance with an embodiment of the present disclosure. For example, in a first interval, the first phase control signal PWM1 is at the high logic level H, and the second phase control signal PWM2 is at the low logic level L. That is, the power switches M1 and M4 are turned on, and the power switches M2 and M3 are turned off. In this interval, the input current flows through the power switch M1, the flying capacitor C_{FLY}, and the inductor L1 to the output terminal Vout, while the current in inductor L2 flows through power switch M4 to the output terminal Vout. The current in inductor L1 increases, and the current in inductor L2 decreases. The input voltage V_{IN} is divided between the flying capacitor C_{FLY} and the output stage.

In a second interval, the first phase control signal PWM1 is at the low logic level L, and the second phase control signal PWM2 is at the low logic level L. Specifically, the power switch M1 is turned off and the power switch M2 is turned on, the current in inductor L1 flows through the power switch M2, and therefore the energy stored in inductor L1 starts to discharge to the output terminal Vout, while the current in inductor L2 continues to decrease.

In a third interval, the first phase control signal PWM1 is at the low logic level L, and the second phase control signal PWM2 is at the high logic level H. The power switch M3 is turned on and the power switch M4 is turned off. During this interval, the current in inductor L2 flows through the power switch M2, the flying capacitor C_{FLY}, the power switch M3, and the inductor L2 to the output terminal Vout, while the current in inductor L1 flows through the power switch M2 to the output terminal Vout. The current in inductor L2 increases, and the current in inductor L1 decreases.

In a fourth interval, the first phase control signal PWM1 is at the low logic level L, and the second phase control signal PWM2 is at the low logic level L. The power switch M3 is turned off, which is identical to the second interval. During this interval, both power switches M1 and M3 are off and both power switches M2 and M4 are on, and both inductor currents decrease. Afterwards, the circuit enters a new switching cycle when the power switch M1 is turned on again.

However, when the high side of second phase is turned on (e.g., PWM2=H) after the first output current iL1 (e.g., in inductor L1) has reached zero, a reverse current may occur at the inductor L1. That is, the negative inductor current in the first phase (e.g., when the first inductor current starts at zero and goes in a negative direction) occurs during the third interval when the switch M2 (low side of the first phase) is turned on and the switch M3 (high side of the second phase) is also turned on. This reverse current leads to additional losses. This occurs more frequently during light-load conditions since the load current flowing through the inductor decreases to zero more quickly. Furthermore, the reverse current makes the body diode of the switch M2 (low side of the first phase) conducted when the high side of second phase is turned on (e.g., PWM2 =H). Similarly, during the fourth interval when the high side of second phase is turned off (e.g., PWM2 =L), a reverse current may occur to makes the body diode of the switch M1 (high side of the first phase) conducted. This additional losses reduce the efficiency of the switching converter.

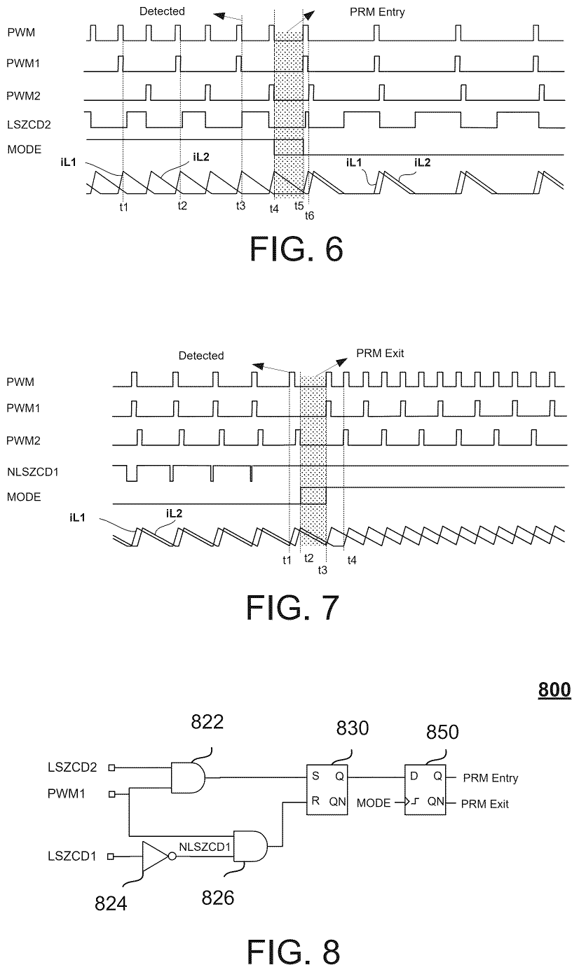

FIG. 6 shows the phase replicate mode entry process in accordance with an embodiment of the present disclosure. As shown in FIG. 6, the control signal is distribute evenly to the two phases, and thus the two phase are interleaved. Specifically, the first output current iL1 of the first phase increases and decreases in response to the first phase control signal PWM1, and the second output current iL2 of the second phase increases and decreases in response to the second phase control signal PWM2. The zero crossing signal LSZCD2 indicates whether the inductor current iL2 is essentially zero. A high logic level of the zero crossing signal LSZCD2 indicates the inductor current iL2 is essentially zero.

In one embodiment, whether to trigger the PRM is detected at the falling edge of the first phase control signal PWM1. For instance, at the falling edge of the first phase control signal PWM1 (i.e., time t1), the second output current iL2 of the second phase is greater than essentially zero. That is, the zero crossing signal LSZCD2 is not triggered and remain at the low logic level. Therefore, the PRM is not triggered, and the power stage IC operates in PIM (the signal MODE is at the high logic level). Similarly, at time t2, the second output current iL2 of the second phase is greater than essentially zero (i.e., LSZCD2=L), the power stage IC operates in PIM. At time t3, the second output current iL2 of the second phase is essentially zero, i.e., the zero crossing signal LSZCD2 is at the high logic level. When the zero crossing signal LSZCD2 is detected at the falling edge of the first phase control signal PWM1, a PRM is triggered.

In another embodiment, whether to trigger the PRM is detected at the rising edge of the first phase control signal PWM1. In some embodiments, whether to trigger the PRM is detected at the rising edge or falling edge of the second phase control signal PWM2. For example, when the first output current iL1 of the first phase reaches essentially zero (i.e., the first zero crossing signal LSZCD1 is at the high logic level) at the rising edge of the second phase control signal PWM2, the PRM is triggered.

In one embodiment, the mode switching happens at the next switching cycle. For example, at next rising edge of the first phase control signal PWM1 (i.e., at time t5), PRM is entered. When PRM is entered, the signal MODE is at the low logic level, and the second phase control signal PWM2 transitions to the high logic level at time t6 to turn on the high side of the second phase before the first output current iL1 flowing through the inductor L1 decreases to essentially zero. That is, the second high-side switch M3 turned on during a time period when the first low-side switch M2 is turned on. This avoids the potential current flowing through the body diode of the switch M2 and the potential current flowing through the body diode of the switch M1. In another embodiment, the mode switching happens at the next falling edge of the second phase control signal PWM2 (i.e., at time t4).

FIG. 7 shows the phase replicate mode exit process in accordance with an embodiment of the present disclosure. In one embodiment, whether to exit the PRM is detected at the rising edge of the first phase control signal PWM1. For instance, at the rising edge of the first phase control signal PWM1 (i.e., time t1), the first output current iL1 of the first phase is greater than essentially zero. That is, the signal NLSZCD1 is at the high logic level, which indicates there is enough positive current in the first phase, and the zero crossing signal LSZCD1 is not triggered. Therefore, when the zero crossing signal NLSZCD1 is detected at the rising edge of the first phase control signal PWM1, a PRM is triggered. In one embodiment, the mode switching happens at the next switching cycle. For example, at the next rising edge of the first phase control signal PWM1 (i.e., at time t3), PRM is exited and PIM is entered, and the signal MODE is at the high logic level. During the PIM, the first phase control signal PWM1 is interleaved with the second phase control signal PWM1. For instance, the phase shift between each phase control signal PWM 1/PWM2 are the same (e.g., 180° for two phases). The second phase control signal PWM2 transitions to the high logic level at time t4 (which is synchronous with the control signal PWM) to turn on the high side of the second phase. In another embodiment, the mode switching happens at the next falling edge of the second phase control signal PWM2 (i.e., at time t2).

In some embodiments, whether to trigger the PIM is detected at the rising edge of the second phase control signal PWM2. For example, when the second output current iL2 of the second phase is greater than essentially zero, the second zero crossing signal LSZCD2 is at the low logic level at the rising edge of the second phase control signal PWM2. In other words, when there is enough current in the second phase at the rising edge of the second phase control signal PWM2, the PIM is triggered. In one embodiment, the mode switching happens at the next rising edge of the first phase control signal PWM1. In another embodiment, the mode switching happens at the next falling edge of the first phase control signal PWM1.

FIG. 8 is a schematic circuit diagram of a mode selection circuit 800 in accordance with an embodiment of the present disclosure. The mode selection circuit 800 includes logic circuits. For instance, the mode selection circuit 800 includes a AND gate 822, a NOT gate 824, an AND gate 826, an SR latch 830, and a D flip-flop 850. Specifically, a AND gate 822 is configured to receive the second zero crossing signal LSZCD2 and the first phase control signal PWM1 to set the SR latch 830, and therefore the D flip-flop 850 generates a PRM entry signal when the second zero crossing signal and the first phase control signal both are at the high logic level in response to the clock signal MODE. In one embodiment, the mode switching happens at the rising edge of the first phase control signal PWM1. In another embodiment, the mode switching happens at the falling edge of the second phase control signal PWM2.

On the other hand, the AND gate 826 is configured to receive the inverted first zero crossing signal NLSZCD1 and the first phase control signal PWM1 to reset the SR latch 830. Accordingly, the D flip-flop 850 generates a PRM exit signal when the inverted first zero crossing signal NLSZCD1 and the first phase control signal PWM1 both are at the high logic level in response to the clock signal MODE.

By automatically entering/exiting PRM during light load, the switching converter avoid any negative inductor current of the first phase, such that the body diode of the first low side switch will not be conducted when the second phase control signal PWM2 is on, and the body diode of the first high-side will not be conducted when the second phase control signal PWM2 is off. Therefore, this improves the efficiency and reliability of the switching converter.

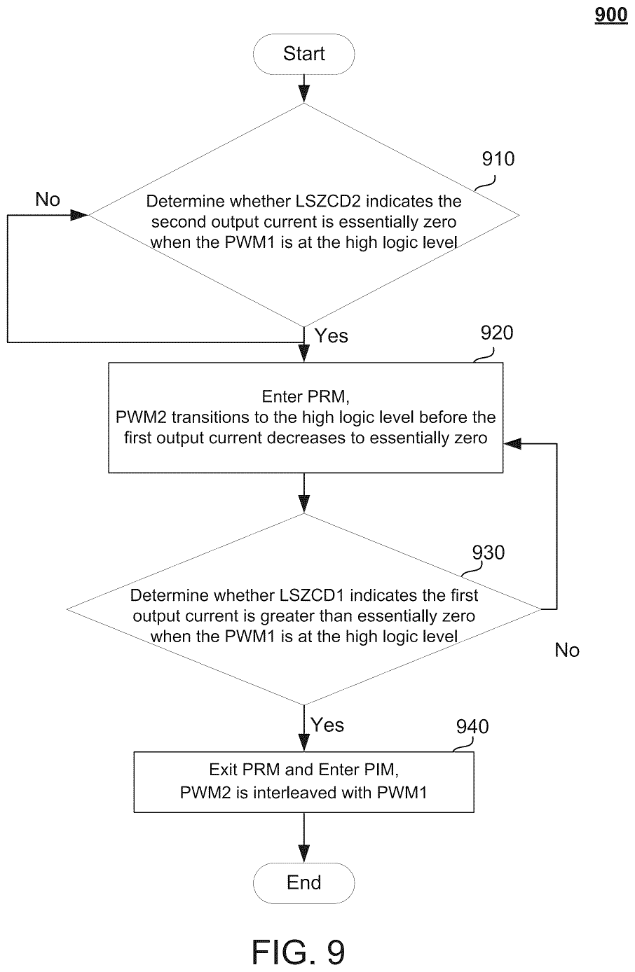

FIG. 9 is a flowchart of a method for controlling a switching capacitor converter in accordance with one embodiment of the present disclosure. The method 900 may be performed by the power stage IC 300, 400 as shown in FIGS. 3-4. The method includes the following actions. In action 910, when the first phase control signal is at the high logic level, whether the second zero crossing signal indicates the second output current is essentially zero is determined. When the second output current is essentially zero, action 920 is performed. In action 920, the phase replicate mode is entered at the next cycle. During the phase replicate mode, the second phase control signal transitions to a high logic level before the first output current decreases to essentially zero. In action 930, whether the first zero crossing signal indicating the first output current is greater than essentially zero is determined when the first phase control signal is at the high logic level. When the first output current is greater than essentially zero, action 940 is performed. In action 940, the phase interleave mode is entered at the next cycle. Although the flowchart of FIG. 9 shows a sequential action. It is obvious to persons skilled the art that these actions could be performed in any order.

It should be understood that, the circuit and the related components, circuit structures, signals, and waveforms described or shown above in the present disclosure are only for illustration purpose. However, the present disclosure is not limited thereto. Persons having ordinary skill in the art may understood that the control circuit of the present disclosure could be realized, according to practical applications, by any other circuits with different circuit structures, and thus controlled by different types of the corresponding signals to achieve the corresponding functions. For example, the circuit could be realized by a digital circuit, an analog circuit, a software, an automatic generation circuit by hardware description language, or a combination of the above.

It will be appreciated by persons skilled in the art that the present disclosure is not limited to what has been particularly shown and described herein above. Rather the scope of the present disclosure is defined by the claims and includes both combinations and sub-combinations of the various features described hereinabove as well as variations and modifications thereof which would occur to persons skilled in the art upon reading the foregoing description and which are not in the prior art.

What is claimed is:

1. A power stage circuit, comprising:
a first phase switch circuit, having at least one switch, configured to provide a first output current;
a second phase switch circuit, having at least one switch, configured to provide a second output current, wherein the first phase switch circuit is configured to be coupled to the second phase switch circuit via a first flying capacitor;
a driving control circuit configured to receive a control signal and provide a first phase control signal to the first phase switch circuit, and provide a second phase control signal to the second phase switch circuit;
a zero current detection circuit configured to generate a first zero crossing signal indicating whether the first output current is essentially zero, and generate a second zero crossing signal indicating whether the second output current is essentially zero; and
a mode selection circuit configured to receive the first zero crossing signal and the second zero crossing signal, and trigger a phase replicate mode in response to the second zero crossing signal and the first phase control signal;
wherein during the phase replicate mode, the second phase control signal transitions to a high logic level before the first output current decreases to essentially zero.

2. The power stage circuit of claim 1, wherein the phase replicate mode is triggered when the second zero crossing signal indicating the second output current is essentially zero is detected when the first phase control signal is at the high logic level.

3. The power stage circuit of claim 2, wherein the phase replicate mode is triggered at a falling edge of the first phase control signal.

4. The power stage circuit of claim 1, wherein the mode selection circuit is further configured to trigger a phase interleave mode in response to the first zero crossing signal and the first phase control signal, and wherein during the phase interleave mode, the second phase control signal is interleaved with the first phase control signal.

5. The power stage circuit of claim 4, the phase interleave mode is triggered when the first zero crossing signal indicating the first output current is greater than essentially zero is detected when the first phase control signal is at the high logic level.

6. The power stage circuit of claim 5, wherein the phase interleave mode is triggered at a rising edge of the first phase control signal.

7. The power stage circuit of claim 1, wherein the first phase switch circuit comprises:
a first high-side switch having a first terminal, a second terminal and a third terminal, wherein the first terminal of the first high-side switch is configured to receive an input voltage; and
a first low-side switch having a first terminal, a second terminal and a third terminal, wherein the first terminal of the first low-side switch is coupled to the second terminal of the first high-side switch via the first flying capacitor, and the second terminal of the first low-side switch is configured to be coupled to a reference voltage level; and
wherein the second phase switch circuit comprises:
a second high-side switch having a first terminal, a second terminal and a third terminal, wherein the first terminal of the second high-side switch is coupled to the second terminal of the first high-side switch; and
a second low-side switch having a first terminal, a second terminal and a third terminal, wherein the first terminal of the second low-side switch is coupled to the second terminal of the second high-side switch, and the second terminal of the second low-side switch is configured to be coupled to the reference voltage level.

8. The power stage circuit of claim 1, wherein during the phase replicate mode, the second high-side switch turned on during a time period when the first low-side switch is turned on.

9. The power stage circuit of claim 1, wherein the first phase switch circuit comprises:
a first switch having a first terminal, a second terminal and a third terminal, wherein the first terminal of the first switch is configured to receive an input voltage;
a second switch having a first terminal, a second terminal and a third terminal, wherein the second terminal of the second switch is coupled to the second terminal of the first switch via the first flying capacitor; and
a third switch having a first terminal, a second terminal and a third terminal, wherein, wherein the first terminal of the third switch is coupled to the second terminal of the second switch, and the second terminal of the third switch is configured to be coupled to a reference voltage level; and
wherein the second phase switch circuit comprises:
a fourth switch having a first terminal, a second terminal and a third terminal, wherein the first terminal of the fourth switch is configured to receive an input voltage, and the second terminal of the fourth switch is coupled to the first terminal of the second switch;
a fifth switch having a first terminal, a second terminal and a third terminal, wherein the first terminal of the fifth switch is coupled to the second terminal of the first switch, the second terminal of the fifth switch is coupled to the second terminal of the fourth switch via a second flying capacitor ; and
a sixth switch having a first terminal, a second terminal and a third terminal, wherein the first terminal of the sixth switch is coupled to the second terminal of the fifth switch, and the second terminal of the sixth switch is configured to be coupled to the reference voltage level.

10. The control circuit of claim 1, wherein the mode selection circuit comprises:
a logic circuit configured to receive the second zero crossing signal and the first phase control signal, and generate a phase replicate mode entry signal when the second zero crossing signal and the first phase control signal both are at the high logic level.

11. The control circuit of claim 10, wherein the logic circuit is further configured to receive the first zero crossing signal, and generate a phase replicate mode exit signal when the first zero crossing signal is at a low logic level and the first phase control signal is at the high logic level.

12. An integrated circuit, comprising:
a switching control pin configured to receive a control signal;
a first switching pin configured to provide a first output current;
a second switching pin configured to provide a second output current;
a first high-side switch having a first terminal, a second terminal and a third terminal, wherein the first terminal of the first high-side switch is configured to receive an input voltage;
a first low-side switch having a first terminal, a second terminal and a third terminal, wherein the first terminal of the first low-side switch is coupled to the first switching pin, and the second terminal of the first low-side switch is configured to be coupled to a reference voltage level;
a second high-side switch having a first terminal, a second terminal and a third terminal, wherein the first terminal of the second high-side switch is coupled to the second terminal of the first high-side switch;
a second low-side switch having a first terminal, a second terminal and a third terminal, wherein the first terminal of the second low-side switch is coupled to the second terminal of the second high-side switch and the second switching pin, and the second terminal of the second low-side switch is configured to be coupled to the reference voltage level; and
a driving control circuit configured to receive a control signal and provide a first driving signal to the first high-side switch, provide a second driving signal to the first low-side switch, provide a third driving signal to the second high-side switch and provide a fourth driving signal to the second low-side switch;
wherein a phase replicate mode is triggered in response to a second zero crossing signal and the control signal, wherein the second zero crossing signal indicates whether the second output current is essentially zero, and
wherein when the phase replicate mode is triggered, the third driving signal overlaps with the second driving signal.

13. The integrated circuit of claim 12, wherein the driving control circuit is further configured to generate a first phase control signal and a second phase control signal in response to the control signal; and wherein the first driving signal is at a high logic level when the first phase control signal is at the high logic level, the second driving signal at a high logic level when the first phase control signal is at the low logic level, the third driving signal is at the high logic level when the second phase control signal is at the high logic level, and the fourth driving signal at a high logic level when the second phase control signal is at the low logic level.

14. The integrated circuit of claim 12, wherein the phase replicate mode is triggered when the second zero crossing signal indicating the second output current is essentially zero is detected when the first phase control signal is at the high logic level.

15. The integrated circuit of claim 14, wherein the phase replicate mode is triggered at a falling edge of the control signal.

16. The integrated circuit of claim 12, wherein a phase interleave mode is triggered when a first zero crossing signal indicating the first output current is greater than essentially zero is detected when the first phase control signal is at the high logic level.

17. The integrated circuit of claim 14, wherein the phase interleave mode is triggered at a rising edge of the control signal.

18. The integrated circuit of claim 12, wherein when the phase replicate mode is triggered, the third driving signal transitions to a high logic level before the first output current decreases to essentially zero.

19. The integrated circuit of claim 12, comprising:
a mode selection circuit configured to receive the first zero crossing signal and the second zero crossing signal, and trigger the phase replicate mode in response to the second zero crossing signal and the control signal, and trigger a phase replicate mode in response to the first zero crossing signal and the control signal.

20. The integrated circuit of claim 12, wherein the mode selection circuit comprises:
a logic circuit configured to receive the second zero crossing signal and the control signal, and generate a phase replicate mode entry signal when the second zero crossing signal and the control signal both are at the high logic level.

21. The integrated circuit of claim 20, wherein the logic circuit is further configured to receive the first zero crossing signal, and generate a phase replicate mode exit signal when the first zero crossing signal is at a low logic level and the control signal is at the high logic level.

22. A gate driving circuit for a switching capacitor converter, comprising:
a driving control circuit configured to receive a control signal, provide a first phase control signal to a first phase switch circuit, and provide a second phase control signal to a second phase switch circuit; and
a zero current detection circuit configured to generate a first zero crossing signal indicating whether a first output current is essentially zero, and generate a second zero crossing signal indicating whether a second output current is essentially zero; and
a mode selection circuit configured to receive the first zero crossing signal and the second zero crossing signal, and trigger a phase replicate mode in response to the second zero crossing signal and the first phase control signal;
wherein when the phase replicate mode is triggered, the second phase control signal transitions to a high logic level before the first output current decreases to essentially zero.

23. The gate driving circuit of claim 22, wherein the phase replicate mode is triggered when the second zero crossing signal indicating the second output current is essentially zero is detected at a falling edge of the first phase control signal.

24. The gate driving circuit of claim 22, wherein the mode selection circuit is further configured to trigger a phase interleave mode when the first zero crossing signal indicating the first output current is greater than essentially zero is detected at a rising edge of the first phase control signal; and wherein when the phase interleave mode is triggered, the second phase control signal is interleaved with the first phase control signal.

25. The gate driving circuit of claim 22, wherein during the phase replicate mode, the first output current decreases during a time period when the second output current increases.

26. The gate driving circuit of claim 22, wherein the mode selection circuit comprises:
a logic circuit configured to receive the second zero crossing signal and the first phase control signal, and generate a phase replicate mode entry signal when the second zero crossing signal and the first phase control signal both are at the high logic level.

27. The gate driving circuit of claim 22, wherein the logic circuit is further configured to receive the first zero crossing signal, and generate a phase replicate mode exit signal when the first zero crossing signal is at a low logic level and the first phase control signal is at the high logic level.
